(19) United States
(12) Patent Application Publication
(10) Pub. No.: US 2026/0342576 A1
(43) Pub. Date: Oct. 29, 2026

(54) SYSTEM AND METHOD FOR FACILITATING DECENTRALIZED IDENTITY MANAGEMENT

(71) Applicant: Amit DUA, Haryana (IN)

(72) Inventors: Amit DUA, Haryana (IN); Arijeet SENGUPTA, West Bengal (IN); Ipshita MAHAPATRA, Maharashtra (IN)

(21) Appl. No.: 19/485,482

(22) PCT Filed: Apr. 22, 2024
(86) PCT No.: PCT/IB2024/053904

§ 371 Date: Nov. 18, 2025

(30) Foreign Application Priority Data
Jun. 16, 2023 (IN) 202311041001

(51) Int. Cl. H04L 9/32

(52) U.S. Cl. CPC H04L 9/3218; H04L 9/3231; H04L 9/3239

(57) ABSTRACT

Present invention discloses a system and a method for facilitating decentralized identity management. System receive at least one data packet from one or more computing device associated with one or more user. System stores at least one data packet in a decentralized identity network for enabling the one more user to control the identity data. System generates and transmit a zero-knowledge proof corresponding to the at least one data packet to perform an authentication process of the one or more user. System verifies the zero-knowledge proof without accessing the identity data and grant access to a requested service by facilitating decentralized identity management, and enable seamless interoperability between one or more platforms and services upon successful verification.

### TECHNICAL FIELD

The present invention relates to the field of authentication systems. In particular, it relates to a system and method facilitating decentralized identity management, by verifying the identity of an individual in real-time to enhance user experience.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

Identity management and authentication systems have evolved significantly over the past few decades. Traditionally, identity management has been centralized, with user information stored and managed by a single authority or organization. The centralized identity management has led to several issues, including data breaches, single points of failure, lack of user control, limited interoperability, and inefficient authentication. To address the above said problems, researchers and developers have explored various alternatives, such as decentralized identity solutions, zero-knowledge proofs, federated identity management, and privacy-enhancing technologies.

A traditional decentralized identity solutions use blockchain and other decentralized technologies to give users greater control over their identity information, providing better security, privacy, and interoperability. However, they may still require users to reveal sensitive information during the authentication process.

One of the existing approaches is a federated identity management which allows users to access multiple systems using a single set of credentials, without the need for a centralized identity provider. Thus, providing greater interoperability and reduce the risk of a single point of failure. However, it may still be susceptible to data breaches and may not address privacy concerns completely.

Another existing approach is a Zero-knowledge proof which is cryptographic protocols to enable one party to prove to another that they possess certain information without revealing the information. This can be used to provide authentication without requiring users to reveal sensitive information. However, the zero-knowledge proofs alone may not address all the issues related to centralized identity management systems.

Another existing approach is privacy-enhancing technologies which include techniques like differential privacy and homomorphic encryption can be used to protect user data privacy. The said technologies allow data to be analysed without revealing sensitive information. However, they may not be directly applicable to identity management and authentication processes. The drawbacks or deficiencies of these previous attempts include incomplete solutions to the range of problems, limited focus on specific aspects of identity management, or the need for complex integrations to achieve desired outcomes.

Therefore, there is a need for a reliable, and robust system and method facilitating decentralized identity management, by verifying the identity of an individual in real-time to enhance user experience.

### OBJECTS OF THE PRESENT DISCLOSURE

Some of the objects of the present disclosure, which at least one embodiment herein satisfies are as listed herein below.

It is an object of the present disclosure to provide a system and method for facilitating decentralized identity management.

It is another object of the present invention to provide system and method facilitating decentralized identity management, to reduce the risk of unauthorized access and data breaches.

It is another object of the present invention to provide system and method facilitating decentralized identity management, which enables users to self-authentication without revealing the sensitive biometric data, and preserving their privacy throughout the authentication process.

It is another object of the present invention to provide system and method facilitating decentralized identity management, which provides seamless sharing and verification of identity information across various systems and domains, promoting a more interconnected identity ecosystem.

It is another object of the present invention to provide system and method facilitating decentralized identity management, which enables the authentication process to be convenient and user-friendly, reducing the need for complex passwords or other forms of user input.

It is another object of the present invention to provide system and method facilitating decentralized identity management, provides greater privacy and control by empowering the users with control over their identity data and the ability to choose which parties they want to share their information.

### SUMMARY

The present invention relates to the field of authentication systems. In particular, it relates to a system and method facilitating decentralized identity management, by verifying the identity of an individual in real-time to enhance user experience.

An aspect of the present disclosure pertains to a system for facilitating decentralized identity management. The system comprising: one or more pre-processor, a memory coupled to the one or more processor. The memory comprises processor-executable instructions to cause the one or more pre-processors to: receive at least one data packet from one or more computing device associated with one or more user. The at least one data packet pertains to an identity data retrieved from the one or more users which include a biometric data. Further, the system can be configured to store the at least one data packet in a decentralized identity network which enables the one more users to control the identity data. Furthermore, the system can be configured to generate and transmit a zero-knowledge proof corresponding to the at least one data packet to perform an authentication process of the one or more users. Finally, the system can be configured to verify the zero-knowledge proof without accessing the identity data and grant access to a requested service by facilitating decentralized identity management, and seamless interoperability between various platforms and services upon successful verification.

In an aspect, the system can be configured to convert the biometric data into a secure digital template based on a cryptography mechanism, wherein the secure digital template serves as the basis for the authentication requests.

In an aspect, the system can be configured to apply a hash function to the biometric data by using the SHA-256 algorithm to generate a biometric identity (ID). Further, the system can be configured to generate a decentralized identification number (DID) to be associated with the one or more users. Finally, the system can be configured to store a mapping value of the biometric identity (ID) to the decentralized identification number (DID).

In an aspect, the system can be configured to create the zero-knowledge proof by using a zero-knowledge proof generator based on the mapping value. Further, verify the zero-knowledge proof to confirm the identity of the one or more user without accessing the identity data of the one or more user. The system can be configured to grant a secure authentication to the one or more user based on the verification of the zero-knowledge proof. Finally, maintain privacy of the one or more user by preventing access to the identity data of the one or more user during the verification process.

In an aspect, the system can be configured to enable a secure transmission of the identity data and the zero-knowledge proof between the one or more computing device and the decentralized identity network to provide successful authentication of the requested service to the one or more user.

In an aspect, the biometric data comprises at least one of a fingerprint, a facial recognition, and an iris scan.

In an aspect, the decentralized network comprises at least one of a blockchain, a Filecoin, and a Storj.

In an aspect, a method for facilitating decentralized identity management. The method includes steps of receiving, by a system, at least one data packet from one or more computing device associated with one or more user. The at least one data packet pertains to an identity data retrieved from the one or more users which include a biometric data. The method includes steps of storing, by the system, the at least one data packet in a decentralized identity network which enables the one more users to control the identity data. The method includes steps of generating, by the system, and transmit a zero-knowledge proof for the at least one data packet to perform an authentication process of the one or more users. Finally, the method comprises the step of verifying, by the system, the zero-knowledge proof without accessing the identity data and grant access to a requested service by facilitating decentralized identity management, and enable seamless interoperability between one or more platforms and services upon successful verification.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in, and constitute a part of this specification. The drawings illustrate exemplary embodiments of the present disclosure, and together with the description, serve to explain the principles of the present disclosure.

In the figures, similar components, and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates exemplary network architecture of the proposed system for facilitating decentralized identity management, in accordance with an embodiment of the present disclosure.

FIG. 2 illustrates architecture of the proposed system for facilitating decentralized identity management, in accordance with an embodiment of the present disclosure.

FIG. 3 illustrates a block diagram for facilitating decentralized identity management, in accordance with some embodiments of the present disclosure.

FIG. 4 illustrates an exemplary view of a flow diagram of the proposed method for facilitating decentralized identity management, in accordance with an embodiment of the present disclosure.

FIG. 5 illustrates an exemplary computer system in which or with which embodiments of the present invention can be utilized in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

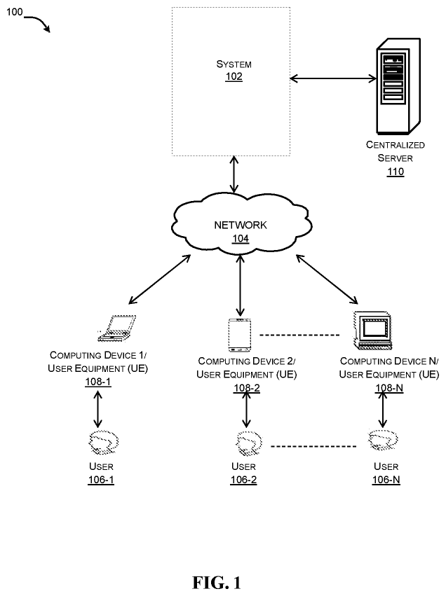

Various aspects of the present disclosure are described with respect to FIG. 1-5.

The present invention relates to the field of authentication systems. In particular, it relates to a system and method facilitating decentralized identity management, by verifying the identity of an individual in real-time to enhance user experience.

An aspect of the present disclosure pertains to a system for facilitating decentralized identity management. The system comprising: one or more pre-processor, a memory coupled to the one or more processor. The memory comprises processor-executable instructions to cause the one or more pre-processors to: receive at least one data packet from one or more computing device associated with one or more user. The at least one data packet pertains to an identity data retrieved from the one or more users which include a biometric data. Further, the system can be configured to store the at least one data packet in a decentralized identity network which enables the one more users to control the identity data. Furthermore, the system can be configured to generate and transmit a zero-knowledge proof corresponding to the at least one data packet to perform an authentication process of the one or more users. Finally, the system can be configured to verify the zero-knowledge proof without accessing the identity data and grant access to a requested service by facilitating decentralized identity management, and seamless interoperability between various platforms and services upon successful verification.

In an aspect, the system can be configured to convert the biometric data into a secure digital template based on a cryptography mechanism, wherein the secure digital template serves as the basis for the authentication requests.

In an aspect, the system can be configured to apply a hash function to the biometric data by using the SHA-256 algorithm to generate a biometric identity (ID). Further, the system can be configured to generate a decentralized identification number (DID) to be associated with the one or more users. Finally, the system can be configured to store a mapping value of the biometric identity (ID) to the decentralized identification number (DID).

In an aspect, the system can be configured to create the zero-knowledge proof by using a zero-knowledge proof generator based on the mapping value. Further, verify the zero-knowledge proof to confirm the identity of the one or more user without accessing the identity data of the one or more user. The system can be configured to grant a secure authentication to the one or more user based on the verification of the zero-knowledge proof. Finally, maintain privacy of the one or more user by preventing access to the identity data of the one or more user during the verification process.

In an aspect, the system can be configured to enable a secure transmission of the identity data and the zero-knowledge proof between the one or more computing device and the decentralized identity network to provide successful authentication of the requested

In an aspect, the biometric data comprises at least one of a fingerprint, a facial recognition, and an iris scan.

In an aspect, the decentralized network comprises at least one of a blockchain, a Filecoin, and a Storj.

In an aspect, a method for facilitating decentralized identity management. The method includes steps of receiving, by a system, at least one data packet from one or more computing device associated with one or more user. The at least one data packet pertains to an identity data retrieved from the one or more users which include a biometric data. The method includes steps of storing, by the system, the at least one data packet in a decentralized identity network which enables the one more users to control the identity data. The method includes steps of generating, by the system, and transmit a zero-knowledge proof for the at least one data packet to perform an authentication process of the one or more users. Finally, the method comprises the step of verifying, by the system, the zero-knowledge proof without accessing the identity data and grant access to a requested service by facilitating decentralized identity management, and enable seamless interoperability between one or more platforms and services upon successful verification.

FIG. 1 illustrates exemplary network architecture 100 of the proposed system 102 for facilitating decentralized identity management, in accordance with an embodiment of the present disclosure.

In an embodiment, referring to FIG. 1, the system 102 will be connected to a network 104, which is further connected to at least one computing devices 108-1, 108-2, . . . 108-N (collectively referred as computing device 108, herein) associated with one or more users devices 106-1, 106-2, . . . 106-N (collectively referred as user 106, herein). The computing device 108 may be personal computers, laptops, tablets, wristwatch or any custom-built computing device integrated within a modern diagnostic machine that can connect to a network as an IoT (Internet of Things) device. Furthermore, the network 104 can be configured with a centralized server 110 that stores compiled data from all the secure transactions.

In an embodiment, the system 102 may receive at least one input data from the at least one computing devices 108. A person of ordinary skill in the art will understand that the at least one computing devices 108 may be individually referred to as computing device 108 and collectively referred to as computing devices 108. In an embodiment, the computing device 110 may also be referred to as User Equipment (UE). Accordingly, the terms “computing device” and “User Equipment” may be used interchangeably throughout the disclosure.

In an embodiment, the computing device 108 may transmit the at least one received data packet over a point-to-point or point-to-multipoint communication channel or network 104 to the system 102.

In an embodiment, the computing device 108 may involve collection, analysis, and sharing of data received from the system 102 via the communication network 104.

In an embodiment, the system 102 may execute one or more instruction for facilitating decentralized identity management that combines a biometric authentication, a zero-knowledge proof, and a decentralized identity solutions.

In an exemplary embodiment, the system 102 may include, but not be limited to, a computer enabled device, a mobile phone, a tablet, a display device, a display projector, a AR/VR/MR, a camera, a sensors, a NFC, a network (Wired or Wireless), an apparatus to dispatch gift, prints, ecommerce, instructions, a Remote Detection Service (Detection Device) enabled devices such as iBeacon technologies, NFC, IR/RF services, bluetooth to detect the devices nearby, a connect signs objects, an apparatus, a vending machine, a gift claw machine, a combination of the vending machine, and the gift claw machine, a drone, a robot, an advertisement displays, or some combination thereof.

In an exemplary embodiment, the communication network 104 may include, but not be limited to, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. In an exemplary embodiment, the communication network 104 may include, but not be limited to, a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the one or more computing devices 110 may communicate with the system 102 via a set of executable instructions residing on any operating system. In an embodiment, the one or more computing devices 110 may include, but not be limited to, any electrical, electronic, electro-mechanical, or an equipment, or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the one or more computing devices 110 may include one or more in-built or externally coupled accessories including, but not limited to, a visual aid device such as camera, audio aid, a microphone, a keyboard, input devices such as touch pad, touch enabled screen, electronic pen, receiving devices for receiving any audio or visual signal in any range of frequencies, and transmitting devices that can transmit any audio or visual signal in any range of frequencies. It may be appreciated that the one or more computing devices 110 may not be restricted to the mentioned devices and various other devices may be used.

In an embodiment, the network 104 is further configured with a centralized server 110 including a database, where the user identity data is used for providing authentication to the users. It can be retrieved based on the requirement.

In an embodiment, the system 102 can be configured to receive at least one data packet from one or more users 106 associated with one or more computing devices 108. The at least one data packet pertains to an identity data retrieved from the one or more users 108 which include a biometric data. Thus, a first connection can be established between the system 102 and the user 106 associated with the computing device 108. The biometric data can include, but not limited to a fingerprint, a facial recognition, an iris scan, and the likes. Further, the system 102 can be configured to apply a hash function to the biometric data by using the SHA-256 algorithm to generate a biometric identity (ID) and generate a decentralized identification number (DID) to be associated with the one or more users. Further, store a mapping value of the biometric identity (ID) to the decentralized identification number (DID). The system 102 can be configured to store the at least one data packet in a decentralized identity network which enables the one more users to control the identity data. The decentralized network can include, but not limited to a blockchain, a Filecoin, a Storj, and the likes.

In another embodiment, the system 102 can be configured to generate and transmit a zero-knowledge proof corresponding to the at least one data packet to perform an authentication process of the user 106. The system 102 can be configured to generate the zero-knowledge proof by using a zero-knowledge proof generator based on the mapping value. Further, the system 102 verifies the zero-knowledge proof to confirm the identity of the user 106 without accessing the identity data of the user 106. Further, grant a secure authentication to the user 106 based on the verification of the zero-knowledge proof. Finally, maintain privacy of the user 106 by preventing access to the identity data of the one or more user during the verification process. The system 102 can be configured to verify the zero-knowledge proof without accessing the identity data and grant access to a requested service by facilitating decentralized identity management, and enable seamless interoperability between one or more platforms and services upon successful verification.

In another embodiment, the system 102 can be configured to enable a secure transmission of the identity data and the zero-knowledge proof between the computing device 108 and the decentralized identity network to provide successful authentication of the requested service to the user 106.

Although FIG. 1 shows exemplary components of the network architecture 100, in other embodiments, the network architecture 100 may include fewer components, different components, differently arranged components, or additional functional components than depicted in FIG. 1. Additionally, or alternatively, one or more components of the network architecture 100 may perform functions described as being performed by one or more other components of the network architecture 100.

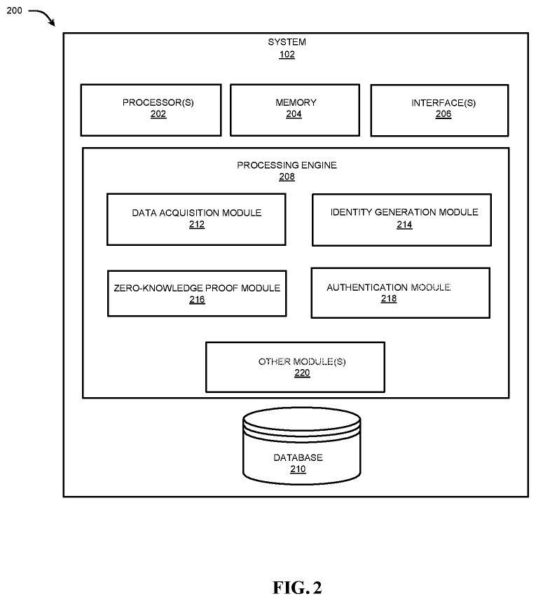

FIG. 2 illustrates architecture of the proposed system for facilitating decentralized identity management, in accordance with an embodiment of the present disclosure.

In an aspect, referring to FIG. 2, the system 102 may comprise one or more processor(s) 202. The one or more processor(s) 202 may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) 202 may be configured to fetch and execute computer-readable instructions stored in a memory 204 of the system 102. The memory 204 may be configured to store one or more computer-readable instructions or routines in a non-transitory computer readable storage medium, which may be fetched and executed to create or share data packets over a network service. The memory 204 may comprise any non-transitory storage device including, for example, volatile memory such as Random Access Memory (RAM), or non-volatile memory such as Erasable Programmable Read-Only Memory (EPROM), flash memory, and the like.

Referring to FIG. 2, the system 102 may include an interface(s) 206. The interface(s) 206 may comprise a variety of interfaces, for example, interfaces for data input and output devices, referred to as I/O devices, storage devices, and the like. The interface(s) 206 may facilitate communication to/from the system 102. The interface(s) 206 may also provide a communication pathway for one or more components of the system 102. Examples of such components include, but are not limited to, processing unit/engine(s) 208 and a local database 210.

In an embodiment, the processing unit/engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor-executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 102 may comprise the machine-readable storage medium storing the instructions and the processing resource to execute the instructions, or the machine-readable storage medium may be separate but accessible to the system 102 and the processing resource. In other examples, the processing engine(s) 208 may be implemented by electronic circuitry.

In an embodiment, the local database 210 may comprise data that may be either stored or generated as a result of functionalities implemented by any of the components of the processor 202 or the processing engines 208. In an embodiment, the local database 210 may be separate from the system 102.

In an exemplary embodiment, the processing engine 208 may include one or more engines selected from any of a data acquisition module 212, an identity generation module 214, a zero knowledge proof module 216, an authentication module 218 and other modules 220 having functions that may include but are not limited to testing, storage, and peripheral functions, such as wireless communication unit for remote operation, audio unit for alerts and the like.

In an embodiment, the data acquisition module 212 may include means receiving at least one data packet from the users 106 associated with the computing devices 108, the at least one data packet pertains to an identity data retrieved from the users 106 which include a biometric data.

In an embodiment, the identity generation module 214 may be configured to generate a biometric identity (ID) by applying a hash function to the biometric data by using the SHA-256 algorithm. Generate a decentralized identification number (DID) to be associated with the users 106.

In an embodiment, the zero knowledge proof module 216 may be configured to zero-knowledge proof based on the mapping value. Further, verify the zero-knowledge proof to confirm the identity of the users 106 without accessing the identity data.

In an embodiment, the authentication module 218 may be configured to grant a secure authentication to the one or more user based on the verification of the zero-knowledge proof. Further, maintain privacy of the users 106 by preventing access to the identity data of the one or more user during the verification process.

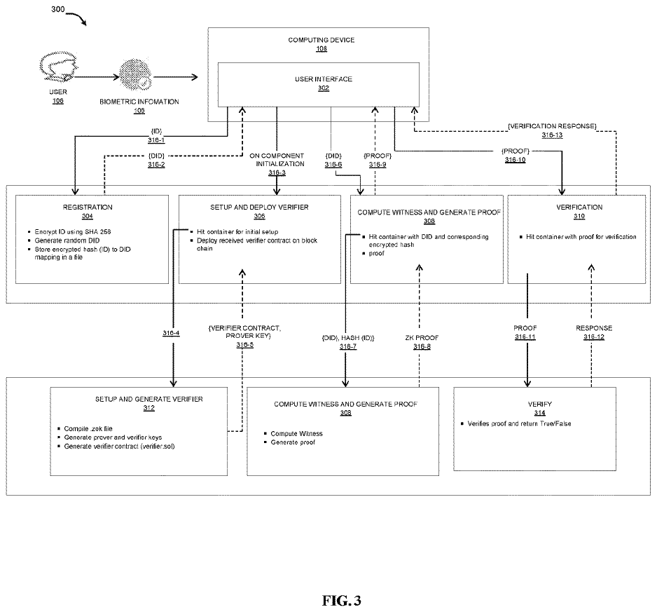

FIG. 3 illustrates a block diagram for facilitating decentralized identity management, in accordance with some embodiments of the present disclosure.

In an embodiment, referring to FIG. 3, the user 106 registers for the first time, the computing device 108 captures the user's biometric data using the integrated biometric sensors (not shown in FIG). The biometric data can include, but not limited to a fingerprint, a facial recognition, an iris scan, and the likes. The system 102 can include various steps such as a registration 304, a setup and deploy verifier 306, a compute witness and generate proof 308, a verification 310, a setup and generate verfier 312, and a verify step 314.

In an embodiment, the registration 304 includes the step 316-1 generating ID by capturing the user's biometric data using the integrated biometric sensors. The system 102 can be configured to apply a hash function to the biometric data by using the SHA-256 algorithm to generate a biometric identity (ID) and generate a decentralized identification number (DID) to be associated with the one or more users. Further, store a mapping value of the biometric identity (ID) to the decentralized identification number (DID). The computing device 108 receives the decentralized identification number DID 316-1 to be associated with the user 106.

In an embodiment, the computing device 108 initiates a on component initialization 316-3 to the setup and deploy verifier 306 which include hit container for initial setup, and deploy received verifier contract on block chain. The initial setup phase is conducted where the zok file is compiled and the verifier contract is deployed into the blockchain. Further, the setup and generate verifier 312 receives input from the setup and deploy verifier 306. The setup and generate verifier 312 can compile .zok file, generate prover and verifier keys, and generate verifier contract (verifier.sol). The mapping information is then added to the .zok file (manually in v1 of the application) which is used for the ZKP part of the application. The .zok file is modified to include this information and placed back into the Zokrates Docker container. The output {VERIFIER CONTRACT, PROVER KEY} 316-5 is provided to the the setup and deploy verifier 306

In an embodiment, the compute witness and generate proof 308 received the decentralized identification number (DID) 316-6 from the computing device 108 to generate {DID}, HASH (ID)} 316-7. Further, the witness is computed and proof is generated ZK PROOF 316-8 and provided to the computing device 108. Furthermore, the {PROOF} 316-10 is provided to the verification 310 to retrieve the executed {VERIFICATION RESPONSE} 316-13, based on PROOF 316-11 and RESPONSE 316-12. When the user 106 needs to authenticate them, the zero-knowledge proof generator creates a proof based on the hashed biometric ID to DID mapping. The authentication module 218 verifies the submitted zero-knowledge proof without accessing the user's actual biometric data and grants access to the requested service or resource upon successful verification.

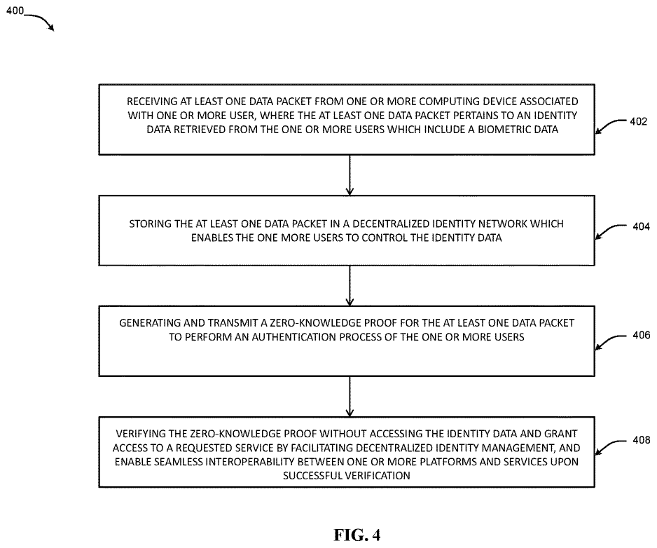

FIG. 4 illustrates an exemplary view of a flow diagram of the proposed method for facilitating decentralized identity management, in accordance with an embodiment of the present disclosure.

In an embodiment, the proposed method 400 for facilitating decentralized identity management. At step 402, receiving, by a system 102, at least one data packet from the computing device 108 associated with the user 106. The at least one data packet pertains to an identity data retrieved from the user 106 which include a biometric data. At step 402, storing, by the system 102, the at least one data packet received from step 402, in a decentralized identity network which enables the user 106 to control the identity data. At step 406, generating, by the system 102, and transmit a zero-knowledge proof for the at least one data packet to perform an authentication process of the user 106. Finally, at step 408 verifying, by the system 102, the zero-knowledge proof without accessing the identity data and grant access to a requested service by facilitating decentralized identity management, and enable seamless interoperability between one or more platforms and services upon successful verification.

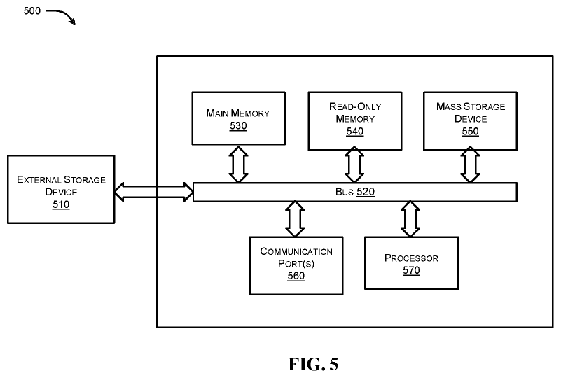

FIG. 5 illustrates an exemplary computer system in which or with which embodiments of the present invention can be utilized in accordance with embodiments of the present disclosure.

Referring to FIG. 5, computer system includes an external storage device 510, a bus 520, a main memory 530, a read only memory 540, a mass storage device 550, communication port 560, and a processor 570. A person skilled in the art will appreciate that computer system may include more than one processor and communication ports. Examples of processor 570 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 470 may include various modules associated with embodiments of the present invention. Communication port 560 can be any of an RS-232 port for use with a modem based dialup connection, a 10/100 Ethernet port, a Gigabit or 10 Gigabit port using copper or fiber, a serial port, a parallel port, or other existing or future ports. Communication port 560 may be chosen depending on a network, such a Local Area Network (LAN), Wide Area Network (WAN), or any network to which computer system connects.

In an embodiment, the memory 530 can be Random Access Memory (RAM), or any other dynamic storage device commonly known in the art. Read only memory 540 can be any static storage device(s) e.g., but not limited to, a Programmable Read Only Memory (PROM) chips for storing static information e.g., start-up or BIOS instructions for processor 570. Mass storage 560 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7102 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

In an embodiment, the bus 520 communicatively couples processor(s) 570 with the other memory, storage and communication blocks. Bus 520 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 570 to software system.

In another embodiment, operator and administrative interfaces, e.g. a display, keyboard, and a cursor control device, may also be coupled to bus 520 to support direct operator interaction with computer system. Other operator and administrative interfaces can be provided through network connections connected through communication port 560. External storage device 510 can be any kind of external hard-drives, floppy drives, IOMEGA® Zip Drives, Compact Disc- Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

It is to be appreciated by a person skilled in the art that while various embodiments of the present disclosure have been elaborated for system and method for facilitating decentralized identity management. However, the teachings of the present disclosure are also applicable for other types of applications as well, and all such embodiments are well within the scope of the present disclosure. However, the system and method facilitating decentralized identity management is also equally implementable in other industries as well, and all such embodiments are well within the scope of the present disclosure without any limitation.

Accordingly, the present disclosure provides a system and method for facilitating decentralized identity management.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions or examples, which are included to enable a person having ordinary skill in the art to make and use the disclosure when combined with information and knowledge available to the person having ordinary skill in the art.

### ADVANTAGES OF THE PRESENT DISCLOSURE

The present disclosure provides a system and method facilitating decentralized identity management.

The present disclosure provides system and method facilitating decentralized identity management, to reduce the risk of unauthorized access and data breaches.

The present disclosure provides system and method for enabling users to self-authentication without revealing the sensitive biometric data, and preserving their privacy throughout the authentication process.

The present disclosure provides system and method for seamlessly sharing and verification of identity information across various systems and domains, promoting a more interconnected identity ecosystem.

The present disclosure provides system and method providing rewards for personalized user engagements using intelligent interactive display, which enables contactless authentication, transaction, gift, product dispatching system.

The present disclosure provides a system and method enables the authentication process to be convenient and user-friendly, reducing the need for complex passwords or other forms of user input.

The present disclosure provides greater privacy and control by empowering the users with control over their identity data and the ability to choose which parties they want to share their information.

1. A system for facilitating decentralized identity management, the system comprising:
one or more processors coupled with a memory, wherein said memory stores instructions which when executed by the one or more processors causes the system to:
receive at least one data packet from one or more computing device associated with one or more user wherein the at least one data packet pertains to an identity data retrieved from the one or more user which include a biometric data;
store the at least one data packet in a decentralized identity network which enables the one more user to control the identity data;
generate and transmit a zero-knowledge proof corresponding to the at least one data packet to perform an authentication process of the one or more user; and verify the zero-knowledge proof without accessing the identity data and grant access to a requested service by facilitating decentralized identity management, and enable seamless interoperability between one or more platforms and services upon successful verification.

2. The system as claimed in claim 1, wherein the system is configured to: convert the biometric data into a secure digital template based on a cryptography mechanism, wherein the secure digital template serves as the basis for the authentication requests.

3. The system as claimed in claim 1, wherein the system is configured to: apply a hash function to the biometric data by using the SHA-256algorithm to generate a biometric identity (ID); generate a decentralized identification number (DID) to be associated with the one or more user; and
store a mapping value of the biometric identity (ID) to the decentralized identification number (DID).

4. The system as claimed in claim 1, wherein the system is configured to:
generate the zero-knowledge proof by using a zero-knowledge proof generator based on the mapping value;
verify the zero-knowledge proof to confirm the identity of the one or more user without accessing the identity data;
grant a secure authentication to the one or more user based on the verification of the zero-knowledge proof; and
maintain privacy of the one or more user by preventing access to the identity data of the one or more user during the verification process.

5. The system as claimed in claim 1, wherein the system is configured to: enable a secure transmission of the identity data and the zero-knowledge proof between the one or more computing device and the decentralized identity network to provide successful authentication of the requested service to the one or more user.

6. The system as claimed in claim 1, wherein the biometric data comprises at least one of a fingerprint, a facial recognition, and an iris scan.

7. A method for facilitating decentralized identity management, the method comprising the steps of:
receiving, by one or more processors of a system at least one data packet from one or more computing device associated with one or more user, wherein the at least one data packet pertains to an identity data retrieved from the one or more user which include a biometric data;
storing, by the one or more processors of the system, the at least one data packet in a decentralized identity network which enables the one more user to control the identity data;
generating, by the one or more processors of the system, and transmit a zero-knowledge proof for the at least one data packet to perform an authentication process of the one or more user; and
verifying, by the one or more processors of the system, the zero-knowledge proof without accessing the identity data and grant access to a requested service by facilitating decentralized identity management, and enable seamless interoperability between one or more platforms and services upon successful verification.
